(19) United States
(12) Patent Application Publication
(10) Pub. No.: US 2024/0292351 A1
(43) Pub. Date: Aug. 29, 2024

(54) UPLINK SYNCHRONIZATION

(71) Applicant: Nokia Technologies Oy, Espoo (FI)

(72) Inventors: Frank FREDERIKSEN, Aalborg (DK); Konstantinos MANOLAKIS, Munich (DE)

(21) Appl. No.: 18/694,231

(22) PCT Filed: Sep. 28, 2021
(86) PCT No.: PCT/EP2021/076591

§ 371 Date: Mar. 21, 2024

(51) Int. Cl. H04W 56/00; H04W 84/06

(52) U.S. Cl. CPC H04W 56/001; H04W 84/06

(57) ABSTRACT

Various example embodiments relate to uplink synchronization. An apparatus may receive, from a device, an alert of expected expiry of at least one validity period of uplink synchronization data. In response to receiving the alert, the apparatus may pause scheduling of data transmissions for the device, or transmit, to the device, an on-demand uplink synchronization assistance signal comprising updated uplink synchronization data.

### RELATED APPLICATION

This application was originally filed as PCT Application No. PCT/EP2021/076591, filed on Sep. 28, 2021, of which is incorporated herein by reference in its entirety.

### TECHNICAL FIELD

Various example embodiments generally relate to the field of wireless communications. Some example embodiments relate to uplink synchronization in non-terrestrial communication networks.

### BACKGROUND

Various wireless communication systems, for example 3GPP 5G New Radio (NR), may provide non-terrestrial network support, for example by including access nodes in satellites or by relaying signals to terrestrial access nodes via satellites. A device, such as for example a user equipment (UE), may be provided with positioning capability, for example by means of an integrated global navigation satellite system (GNSS) device enabling the UE to determine the location of the UE and the current GNSS time. In order to communicate within the wireless communication system, the UE may obtain and maintain uplink synchronization.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

Example embodiments of the present disclosure for example enable a device to maintain uplink synchronization or a network node to mitigate effects of loss of uplink synchronization.

According to a first aspect, an apparatus may comprise at least one processor; and at least one memory including computer program code; the at least one memory and the computer program code configured to, with the at least one processor, cause the apparatus to: transmit, to a network node, an alert of expected expiry of at least one validity period of uplink synchronization data; receive updated uplink synchronization data from the network node; perform uplink synchronization with the updated uplink synchronization data; and transmit an indication of maintained or re-established uplink synchronization to the network node.

According to an example embodiment of the first aspect, the uplink synchronization data comprises at least one of: ephemeris data of a non-terrestrial network node, a common timing advance associated with a feeder link, wherein the feeder link is a link between the non-terrestrial network node and the network node, at least an n-th order derivative of the common timing advance associated with the feeder link, or a device-specific timing advance associated with the feeder link and/or a service link, wherein the service link is a link between the non-terrestrial network node and the apparatus.

According to an example embodiment of the first aspect, the non-terrestrial network node comprises a satellite, and/or wherein the network node comprises a terrestrial network node.

According to an example embodiment of the first aspect, the at least one memory and the computer program code are further configured to, with the at least one processor, cause the apparatus to: determine to transmit the alert, in response to determining that the at least one validity period is expected to expire before reception of a pre-scheduled uplink synchronization assistance signal.

According to an example embodiment of the first aspect, the at least one memory and the computer program code are further configured to, with the at least one processor, cause the apparatus to: receive, after expiry of the at least one validity period, the pre-scheduled uplink synchronization assistance signal, wherein the pre-scheduled uplink synchronization assistance signal comprises the updated synchronization data; perform uplink synchronization or re-establish uplink synchronization with the updated uplink synchronization data; and transmit the indication of the re-established uplink synchronization to the network node.

According to an example embodiment of the first aspect, the pre-scheduled uplink synchronization assistance signal comprises a broadcast signal.

According to an example embodiment of the first aspect, the at least one memory and the computer program code are further configured to, with the at least one processor, cause the apparatus to: receive an indication of paused scheduling of data transmissions.

According to an example embodiment of the first aspect, the at least one memory and the computer program code are further configured to, with the at least one processor, cause the apparatus to: receive, before expiry of the at least one validity period, an on-demand uplink synchronization assistance signal comprising the updated synchronization data; and transmit the indication of the maintained uplink synchronization to the network node.

According to an example embodiment of the first aspect, the on-demand uplink synchronization assistance signal is a device-specific signal.

According to an example embodiment of the first aspect, the indication of the maintained uplink synchronization comprises an acknowledgement of the on-demand uplink synchronization assistance signal.

According to an example embodiment of the first aspect, the at least one memory and the computer program code are further configured to, with the at least one processor, cause the apparatus to: transmit the indication of the maintained or re-established uplink synchronization on a physical uplink control channel, at least one contention-free transmission resource of a physical random access channel, or at least one uplink transmission resource dedicated to the apparatus.

According to an example embodiment of the first aspect, the at least one memory and the computer program code are further configured to, with the at least one processor, cause the apparatus to: communicate data with the network node using at least one scheduled data transmission after transmitting the indication of the maintained or re-established uplink synchronization.

According to a second aspect, a method may comprise transmitting, to a network node, an alert of expected expiry of at least one validity period of uplink synchronization data; receiving updated uplink synchronization data from the network node; performing uplink synchronization with the updated uplink synchronization data; and transmitting an indication of maintained or re-established uplink synchronization to the network node.

According to an example embodiment of the second aspect, the uplink synchronization data comprises at least one of: ephemeris data of a non-terrestrial network node, a common timing advance associated with a feeder link, wherein the feeder link is a link between the non-terrestrial network node and the network node, at least an n th order derivative of the common timing advance associated with the feeder link, or a device-specific timing advance associated with the feeder link and/or a service link, wherein the service link is a link between the non-terrestrial network node and a device.

According to an example embodiment of the second aspect, the non-terrestrial network node comprises a satellite, and/or wherein the network node comprises a terrestrial network node.

According to an example embodiment of the second aspect, the method further comprises: determining to transmit the alert, in response to determining that the at least one validity period is expected to expire before reception of a pre-scheduled uplink synchronization assistance signal.

According to an example embodiment of the second aspect, the method further comprises: receiving, after expiry of the at least one validity period, the pre-scheduled uplink synchronization assistance signal, wherein the pre-scheduled uplink synchronization assistance signal comprises the updated synchronization data; perform uplink synchronization or re-establish uplink synchronization with the updated uplink synchronization data; and transmitting the indication of the re-established uplink synchronization to the network node.

According to an example embodiment of the second aspect, the pre-scheduled uplink synchronization assistance signal comprises a broadcast signal.

According to an example embodiment of the second aspect, the method further comprises: receiving an indication of paused scheduling of data transmissions.

According to an example embodiment of the second aspect, the method further comprises: receiving, before expiry of the at least one validity period, an on-demand uplink synchronization assistance signal comprising the updated synchronization data; and transmitting the indication of the maintained uplink synchronization to the network node.

According to an example embodiment of the second aspect, the on-demand uplink synchronization assistance signal is a device-specific signal.

According to an example embodiment of the second aspect, the indication of the maintained uplink synchronization comprises an acknowledgement of the on-demand uplink synchronization assistance signal.

According to an example embodiment of the second aspect, the method further comprises: transmitting the indication of the maintained or re-established uplink synchronization on a physical uplink control channel, at least one contention-free transmission resource of a physical random access channel, or at least one uplink transmission resource dedicated to the device.

According to an example embodiment of the second aspect the method further comprises: communicating data with the network node using at least one scheduled data transmission after transmitting the indication of the maintained or re-established uplink synchronization.

According to an example embodiment of the second aspect, the method is performed by the device.

According to a third aspect a computer program or a computer program product may comprise instructions for causing an apparatus to perform at least the following: transmitting, to a network node, an alert of expected expiry of at least one validity period of uplink synchronization data; receiving updated uplink synchronization data from the network node; performing uplink synchronization with the updated uplink synchronization data; and transmitting an indication of maintained or re-established uplink synchronization to the network node. The computer program or the computer program product may further comprise instructions for causing the apparatus to perform any example embodiment of the method of the second aspect.

According to a fourth aspect an apparatus may comprise: means for transmitting, to a network node, an alert of expected expiry of at least one validity period of uplink synchronization data; receiving updated uplink synchronization data from the network node; means for performing uplink synchronization with the updated uplink synchronization data; and means for transmitting an indication of maintained or re-established uplink synchronization to the network node. The apparatus may further comprise means for performing any example embodiment of the method of the second aspect. According to a fifth aspect, an apparatus May comprise at least one processor; and at least one memory including computer program code; the at least one memory and the computer program code configured to, with the at least one processor, cause the apparatus at least to: receive, from a device, an alert of expected expiry of at least one validity period of uplink synchronization data; and in response to receiving the alert: pause scheduling of data transmissions for the device, or transmit, to the device, an on-demand uplink synchronization assistance signal comprising updated uplink synchronization data.

According to an example embodiment of the fifth aspect, the uplink synchronization data comprises at least one of: ephemeris data of a non-terrestrial network node, a common timing advance associated with a feeder link, wherein the feeder link is a link between the non-terrestrial network node and a terrestrial network node, at least an n-th order derivative of the common timing advance associated with the feeder link, or a device-specific timing advance associated with the feeder link and a service link, wherein the service link is a link between the device and the non-terrestrial network node.

According to an example embodiment of the fifth aspect, the at least one memory and the computer program code are further configured to, with the at least one processor, cause the apparatus to: transmit a pre-scheduled uplink synchronization assistance signal comprising the updated uplink synchronization data. According to an example embodiment of the fifth aspect, the pre-scheduled uplink synchronization assistance signal comprises a broadcast signal.

According to an example embodiment of the fifth aspect, the at least one memory and the computer program code are further configured to, with the at least one processor, cause the apparatus to: restart scheduling of data transmissions for the device, in response to receiving an indication of re-established uplink synchronization from the device.

According to an example embodiment of the fifth aspect, the on-demand uplink synchronization assistance signal comprises a device-specific signal.

According to an example embodiment of the fifth aspect, the at least one memory and the computer program code are further configured to, with the at least one processor, cause the apparatus to: determine to transmit the on-demand uplink synchronization assistance signal, in response to determining that a priority level associated with the data transmissions meets a condition.

According to an example embodiment of the fifth aspect, the at least one memory and the computer program code are further configured to, with the at least one processor, cause the apparatus to: continue scheduling of data transmissions for the device, in response to receiving an indication of maintained uplink synchronization from the device.

According to an example embodiment of the fifth aspect, the indication of the maintained uplink synchronization comprises an acknowledgement of the on-demand uplink synchronization assistance signal.

According to an example embodiment of the fifth aspect, the at least one memory and the computer program code are further configured to, with the at least one processor, cause the apparatus to: receive the indication of the maintained or re-established uplink synchronization on a physical uplink control channel, at least one contention-free transmission resource of a physical random access channel, or at least one uplink transmission resource dedicated to the device.

According to an example embodiment of the fifth aspect, the at least one memory and the computer program code are further configured to, with the at least one processor, cause the apparatus to: communicate data with the device using at least one scheduled data transmission after receiving the indication of the maintained or re-established uplink synchronization.

According to a sixth aspect, a method may comprise: receiving, from a device, an alert of expected expiry of at least one validity period of uplink synchronization data; and in response to receiving the alert: pausing scheduling of data transmissions for the device, or transmitting, to the device, an on-demand uplink synchronization assistance signal comprising updated uplink synchronization data.

According to an example embodiment of the sixth aspect, the uplink synchronization data comprises at least one of: ephemeris data of a non-terrestrial network node, a common timing advance associated with a feeder link, wherein the feeder link is a link between the non-terrestrial network node and a terrestrial network node, at least an n-th order derivative of the common timing advance associated with the feeder link, or a device-specific timing advance associated with the feeder link and a service link, wherein the service link is a link between the device and the non-terrestrial network node.

According to an example embodiment of the sixth aspect, the method further comprises: transmitting a pre-scheduled uplink synchronization assistance signal comprising the updated uplink synchronization data.

According to an example embodiment of the sixth aspect, the pre-scheduled uplink synchronization assistance signal comprises a broadcast signal.

According to an example embodiment of the sixth aspect, the method further comprises: restarting scheduling of data transmissions for the device, in response to receiving an indication of re-established uplink synchronization from the device.

According to an example embodiment of the sixth aspect, the on-demand uplink synchronization assistance signal comprises a device-specific signal.

According to an example embodiment of the sixth aspect, the method further comprises: determining to transmit the on-demand uplink synchronization assistance signal, in response to determining that a priority level associated with the data transmissions meets a condition.

According to an example embodiment of the sixth aspect, the method further comprises: continuing scheduling of data transmissions for the device, in response to receiving an indication of maintained uplink synchronization from the device.

According to an example embodiment of the sixth aspect, the indication of the maintained uplink synchronization comprises an acknowledgement of the on-demand uplink synchronization assistance signal.

According to an example embodiment of the sixth aspect, the method further comprises: receiving the indication of the maintained or re-established uplink synchronization on a physical uplink control channel, at least one contention-free transmission resource of a physical random access channel, or at least one uplink transmission resource dedicated to the device.

According to an example embodiment of the sixth aspect, the method further comprises: communicating data with the device using at least one scheduled data transmission after receiving the indication of the maintained or re-established uplink synchronization

According to a seventh aspect a computer program or a computer program product may comprise instructions for causing an apparatus to perform at least the following: receiving, from a device, an alert of expected expiry of at least one validity period of uplink synchronization data; and in response to receiving the alert: pausing scheduling of data transmissions for the device, or transmitting, to the device, an on-demand uplink synchronization assistance signal comprising updated uplink synchronization data. The computer program or the computer program product may further comprise instructions for causing the apparatus to perform any example embodiment of the method of the sixth aspect.

According to an eighth aspect an apparatus may comprise: means for receiving, from a device, an alert of expected expiry of at least one validity period of uplink synchronization data; means for pausing scheduling of data transmissions for the device, in response to receiving the alert, or means for transmitting, to the device, an on-demand uplink synchronization assistance signal comprising updated uplink synchronization data, in response to receiving the alert. The apparatus may further comprise means for performing any example embodiment of the method of the sixth aspect.

Any example embodiment may be combined with one or more other example embodiments. Many of the attendant features will be more readily appreciated as they become better understood by reference to the following detailed description considered in connection with the accompanying drawings.

### BRIEF DESCRIPTION OF THE DRAWINGS

The accompanying drawings, which are included to provide a further understanding of the example embodiments and constitute a part of this specification, illustrate example embodiments and together with the description help to understand the example embodiments. In the drawings:

FIG. 1 illustrates an example of a non-terrestrial communication network;

FIG. 2 illustrates an example of a four-step random access procedure;

FIG. 3 illustrates an example of a two-step random access procedure;

FIG. 4 illustrates example of re-establishing uplink synchronization;

FIG. 5 illustrates an example of on-demand delivery of uplink synchronization data;

FIG. 6 illustrates an example of an apparatus configured to practice one or more example embodiments;

FIG. 7 illustrates example of a method for uplink synchronization; and

FIG. 8 illustrates an example of a method for enabling uplink synchronization.

Like references are used to designate like parts in the accompanying drawings.

### DETAILED DESCRIPTION

Reference will now be made to example embodiments, examples of which are illustrated in the accompanying drawings. The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

Devices, such as for example user equipment (UE), may be enabled to access services over a non-terrestrial network (NTN). The non-terrestrial network access may be provided by satellites or other non-terrestrial network nodes such as for example high altitude platform systems (HAPS). Even though some example embodiments have been described using satellites as an example, it is appreciated that, where appropriate, the example embodiments may be applied to other type of non-terrestrial network nodes as well.

Cellular networks, such as for example networks based on 5G New Radio (NR) standards of the 3^{rd} generation parentship project (3GPP), may be configured to support non-terrestrial access. For example, 5G access nodes (gNB) may be deployed onboard satellites or signals may be relayed via satellites to terrestrial gNBs, for example to provide communication coverage over a very large area that may be otherwise unreachable by cellular networks. Non-terrestrial networks may be used for example to connect internet-of-things (IoT) devices globally as well as to provide personal communication in remote areas.

Non-terrestrial networks may exploit low earth orbit (LEO) satellites at altitudes of 500-1500 km. Satellites may be part of a non-terrestrial radio access network (NTN RAN). For example, each satellite may provide a 5G NR service on the earth through one or more satellite beams creating 5G NR cell(s). Due to their low altitude, the LEO satellites may move fast (e.g. 7.5 km/s) relative to the earth and therefore their position with respect to the UE is highly time-variant. This also affects the propagation delay from the ground to the satellite, and vice versa.

Both earth-fixed cells (EFC) and earth-moving cells (EMC) may be used to build a non-terrestrial network. EFC entails the satellite continuously adjusting the pointing direction of the beam to fix the beam and the cell to a specific area on the earth. On the other hand, EMC entails the pointing direction of the beam to be fixed, causing the beam footprint (cell) to move on the earth.

A UE supporting non-terrestrial network access may have positioning capability, for example by means of an integrated global navigation satellite system (GNSS) device. GNSS enables the UE to obtain information about its GNSS location and/or the GNSS time. The UE may therefore obtain information about the time and/or frequency relations between the UE and the satellite, for example in order to perform initial synchronization and to keep synchronized with the non-terrestrial network. Without GNSS, the UE may not be able to access the non-terrestrial network. Furthermore, the time and/or frequency information may be used for other purposes, such as for example mobility, country identification (e.g. for charging or legal procedures), or the like.

In order to access the non-terrestrial network, the UE may perform uplink synchronization. The UE may for example determine a timing advance (TA) for pre-compensating the propagation delay in its uplink transmission. Uplink (UL) may refer to the transmission direction from the UE to the radio access network. Downlink (DL) may refer to the transmission direction from the radio access network to the UE. The UE may further perform frequency pre-compensation to compensate for the Doppler frequency shift expected to be experienced on the service link from the UE to the satellite. Pre-compensation may be done based on the location of the UE and uplink synchronization data received from the radio access network, for example ephemeris data of the serving satellite and/or various type of timing advance data.

The uplink synchronization data may be associated with a validity period, which may define the time the UE can apply the uplink synchronization data without having to acquire an updated version of the uplink synchronization data. However, since the UE may not be mandated to read the uplink synchronization data at specific time instants, the radio access network may not be aware of exact time of the most recent acquisition of the uplink synchronization data by a particular UE. Therefore, the radio access network may not be aware of the exact time the UE loses uplink synchronization, which may result in non-optimal scheduling of data transmissions. Example embodiments of the present disclosure enable the radio access network to obtain information about the upcoming loss of uplink synchronization and to perform counteraction(s) such that scheduling of data transmission may be improved.

According to an example embodiment, a device may transmit an alert of expected expiry of at least one validity period of uplink synchronization data to a network node. The network node may receive the alert and either pause scheduling of data transmissions for the device or transmit an on-demand uplink synchronization assistance signal comprising updated uplink synchronization data to the device. The updated uplink synchronization data may be alternatively, or additionally, provided in a pre-scheduled signal. The device may receive updated uplink synchronization data and perform uplink synchronization with the updated uplink synchronization data. The device may transmit an indication of maintained or re-established uplink synchronization to the network node. This enables the device to maintain uplink synchronization or the network node to mitigate effects of losing the uplink synchronization due to expiry of the validity period.

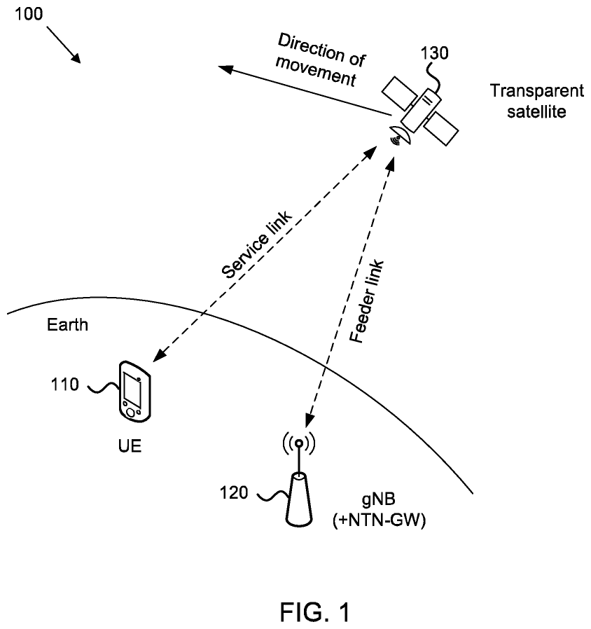

FIG. 1 illustrates an example of a non-terrestrial communication network, according to an example embodiment. Non-terrestrial network (NTN) 100 may comprise a UE 110, which may be located on the earth. A wireless communication link (e.g. service link) may be provided between UE 110 and a satellite 130. Another wireless communication link (e.g. feeder link) may be provided between satellite 130 and an access node, represented in this example by gNB 120. An access node may be also called a base station, a radio access network node, or the like. Non-terrestrial network 100 may further comprise a NTN gateway (GW), which may operate as a link between non-terrestrial nodes of the network and a core network located on the earth. The NTN GW may be co-located with gNB 120.

Satellite 130 may be configured to operate as a transparent satellite, relaying any data transmissions between UE 110 and gNB 120. Alternatively, gNB 120 may be located at satellite 130. Non-terrestrial network 100 may therefore be a satellite network or a satellite-assisted terrestrial network. Non-terrestrial access may be however also provided by other type of non-terrestrial devices, such as for example an aeroplane comprising a HAPS. Similarly, the HAPS itself may comprise an access node, or be configured to relay signals between UE 110 and a terrestrial access node.

In order to communicate within non-terrestrial network 100, UE 110 may synchronize to gNB 120. Since gNB 120 may be accessed via satellite link(s), there may be significant propagation delay between UE 110 and gNB 120. Before establishing a connection to gNB 120, UE 110 may receive from gNB 120 signalling information (uplink synchronization data) enabling UE 110 to perform uplink synchronization. Such information may be provided for example in one or more system information blocks (SIB), which may be transmitted on a physical broadcast channel (PBCH). The uplink synchronization data may comprise ephemeris data of satellite 130. The ephemeris data may be provided for example as state vectors or orbital elements of satellite 130. In either case, UE 110 may be informed about the location and the speed vector of satellite 130 at a given time. The uplink synchronization data may comprise timing advance (TA) data, for example a common timing advance N_{TA,common}, which may be common to UEs served by the respective beam or cell. UE 110 may be further configured to estimate a UE-specific timing advance N_{TA,UE-specific} using GNSS information and ephemeris data of satellite 130. UE 110 may access the non-terrestrial network using a random access (RA) procedure.

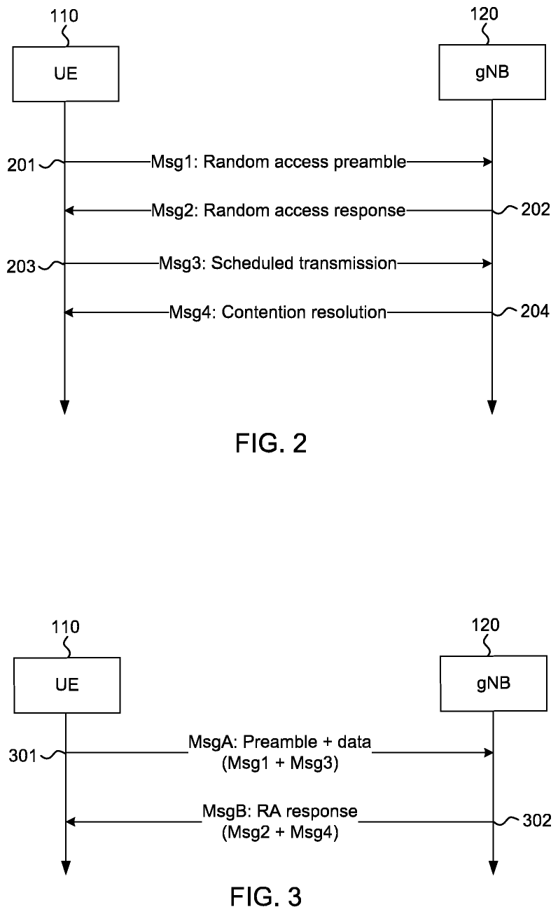

FIG. 2 illustrates an example of a four-step random access procedure between UE 110 and gNB 120.

At operation 201, UE 110 may transmit a random access (RA) preamble. The RA preamble may comprise a first message (Msg1). Msg1 may be also called a random access request. The RA preamble may be transmitted on a physical random access channel (PRACH). The random access preamble may comprise at least one preamble sequence and a cyclic prefix. The cyclic prefix may be located before the preamble sequence(s) in transmission order. gNB 120 may receive the RA preamble. After transmission of the RA preamble the UE 110 may initiate monitoring for a RA response, for example on a physical downlink control channel (PDCCH).

At operation 202, gNB 120 may transmit a random access (RA) response. The RA response may comprise a second message (Msg2). The RA response may comprise an identifier of the RA preamble received by gNB 120 at operation 201. In response to receiving a RA response comprising the identifier of the RA preamble transmitted at operation 201, UE 110 may determine the RA response to be successful and proceed to transmitting a scheduled uplink transmission. In response to not receiving a RA response, for example within a configured RA response window, or failing to verify the RA response, UE 110 may determine that the RA response has failed. In this case, UE 110 may determine to try random access again or determine the RA procedure to have failed.

The RA response may indicate to UE 110, which uplink resources it can use to perform its uplink transmission of following message(s) to gNB 120. The RA response may further comprise an indication of a network configured timing advance to be applied for adjusting the transmit timing of the UE 110, for example as a timing advance command (TAC). The network configured timing advance may be different from the (initial) timing advance used for pre-compensation when transmitting the RA preamble. The UE 110 may apply the network configured timing advance on top of the initial timing advance. For example, a timing advance applied for subsequent messages may comprise a sum of the initial timing advance and the network configured timing advance. This enables UE 110 to further adjust the timing for transmission of subsequent messages.

At operation 203, UE 110 may transmit a scheduled transmission. The scheduled (uplink) transmission may comprise a third message (Msg3). UE 110 may adjust the transmission time of the scheduled transmission based on the indication of the network configured timing advance received at operation 402. This enables to ensure that the scheduled transmission is aligned with other uplink signals from other UEs and thereby to maintain orthogonality between the signals received at gNB 120, even with a relatively short cyclic prefix of the scheduled transmission. The scheduled transmission (Msg3) may comprise control information, for example a medium access control (MAC) control element (CE). Alternatively, or additionally, the scheduled transmission may comprise common control channel (CCCH) information, for example one or more CCCH service data units (SDU). The data carried by the scheduled transmission may hence comprise data submitted from a higher protocol layer. The data may be associated with the UE contention resolution identity, as part of the random access procedure. The scheduled transmission may in general comprise any information scheduled for transmission in the random access procedure after the RA preamble. The UE 110 may initiate a contention resolution timer in response to transmission of the scheduled transmission. The scheduled transmission (Msg3) may be transmitted in response to receiving the RA response (Msg2).

At operation 204, gNB 120 may transmit a contention resolution message. The contention resolution may comprise a fourth message (Msg4). The contention resolution massage may be transmitted on the PDCCH or the physical downlink shared channel (PDSCH). UE 110 may determine the contention resolution to be successful, in response to receiving a contention resolution message addressed to UE 110, for example by a particular value of the cell radio network temporary identifier (C-RNTI).

FIG. 3 illustrates an example of a two-step random access procedure.

At operation 301, UE 110 may transmit a random access preamble and data, for example a physical uplink shared channel (PUSCH) transmission. These messages may be transmitted together (e.g. one after another) and the combination of these messages may be referred to as MsgA. Therefore, MsgA may comprise a first element, Msg1 (=MsgA preamble), and a second element, Msg3 (=MsgA PUSCH). MsgA preamble may comprise a RA preamble similar to operation 201. MsgA PUSCH may comprise information content similar to the scheduled transmission of operation 203. The gNB 120 may receive the RA preamble and the data (PUSCH). Operation 301 may therefore comprise consecutive transmission of the RA preamble and the scheduled transmission. For example, the scheduled transmission may be transmitted before reception of the RA response (response to the RA preamble) from gNB 120. Accordingly, UE 110 may transmit the scheduled transmission without receiving a response to the RA preamble before the scheduled transmission. It is however noted that there may be a time gap between transmission of the RA preamble and the scheduled transmission. The RA preamble and the scheduled transmission may be also transmitted on different channels (e.g. PRACH and PUSCH).

At operation 302, gNB 120 may transmit a RA response and a contention resolution message. These messages may be transmitted together (e.g. one after another) and the combination of these messages may be referred to as MsgB. MsgB may therefore comprise a first element, Msg3 similar to the RA response of operation 202, and a second element, Msg4 similar to the contention resolution of operation 204. Operation 302 may therefore comprise consecutive transmission of the RA response and the contention resolution messages. UE 110 may receive the RA response and the contention resolution message.

It is noted that, contrary to the four-step RA procedure of FIG. 2, in the two-step RA procedure the PUSCH (Msg3) may be transmitted without the network configured timing advance information provided by gNB 120, for example as the timing advance command (TAC). Therefore, the two-step RA procedure may not provide time alignment of the signals transmitted by different UEs prior to transmission of the MsgA PUSCH, and hence this part of the transmission may be more susceptible to timing errors. In this case, the only timing protection mechanism for the PUSCH may be provided by the cyclic prefix (CP), which may be shorter than the cyclic prefix of the RA preamble. Some RA preamble formats allow for a quite extensive duration of the cyclic prefix and therefore, in general, the four-step RA procedure may be less sensitive to timing errors compared to the two-step RA procedure, where the performance may be limited by the shorter cyclic prefix of the MsgA PUSCH.

In general, UE 110 may determine the timing advance T_{TA} to be applied for example based on

$${T}_{T A} = ( {N}_{T A} + {N}_{TA , UE - specific} + {N}_{TA , common} + {N}_{TA , offset} ) \times {T}_{c} ,$$

where N_{TA} may be initially set to zero and updated based on information received from gNB 120. For example, UE 110 may set N_{TA}=0 when transmitting the random access preamble (e.g. MSG1 or MSGA) and update N_{TA} based on the timing advance command (TAC) field received in the random access response (e.g. MSG2 or MSGB) and/or a MAC CE. N_{TA,UE-specific} is the timing advance self-estimated by UE 110 to pre-compensate for the service link delay. N_{TA,common} is the network-controlled common timing advance, which may include any timing offset considered necessary by the network. N_{TA,common} may be equal to zero in some embodiments. N_{TA,offset} may comprise a fixed offset used to calculate the timing advance. It is noted that UE 110 may not assume the round-trip time (RTT) between UE 110 and gNB 120 to be equal to the timing advance calculated for the random access preamble.

Timer(s) may be applied in an open-loop TA update procedure for determining whether uplink synchronization data is still valid. UE-specific and common TA, which may be determined based on the ephemeris data and uplink synchronization assistance information (e.g. common TA, common TA drift rate, and/or higher order derivatives of the common TA) may be valid only during a certain validity period due to the movement of UE 110 and satellite 130. For example, for updating N_{TA,UE-specific} UE 110 may acquire ephemeris data of satellite 130, for example by receiving relevant SIB and using its own propagator model to predict the UE-specific TA during a certain time period without acquiring new ephemeris data. However, the acquired ephemeris data may be valid only during the validity period, depending on several parameters, including for example the propagator model used by UE 110, accuracy of the ephemeris information at the time it is provided, speed and direction of movement of UE 110 and satellite 130, elevation angle (angle between ground and line-of sight (LOS) link to satellite 130), GNSS location information accuracy, maximum tolerable error on the estimation of N_{TA,UE-specific}, or the like. Similarly, for updating N_{TA,common}, the uplink synchronization assistance information, acquired for example in the SIB, may be valid only during a validity period, which may depend on the maximum tolerable error on common TA estimation, the order of common TA approximation to be carried out by UE 110, the speed and direction of movement of UE 110 and satellite 130, elevation angle of the feeder link (angle between gNB and satellite) combined with the distance offset between UE 110 and the orbital plane of the satellite. One timer may be applied to the entire uplink synchronization data or different parameters of the uplink synchronization data may be associated with separate timers.

The validity timer(s) may define the maximum time during which UE 110 may apply the uplink synchronization data (e.g. satellite ephemeris and/or common TA) without acquiring updated uplink synchronization data for TA calculation. For example, a validity timer configured for common TA may define the maximum time during which UE 110 may apply the common TA without acquiring new common TA parameters for common TA calculation. Furthermore, a NTN UE time alignment timer for re-acquisition of the ephemeris data on SIB may configured by the network.

In response to receiving updated ephemeris data and/or uplink synchronization assistance information, UE 110 may start or restart the related timer, or timers if dedicated timers are used for different parameters of the uplink synchronization data. If a timer expires before an update has been received for associated parameter(s), UE 110 may assume that it has lost uplink synchronization and needs to re-synchronize. UE 110 may therefore determine to be in a non-synchronized state, in response to detecting expiry of at least one validity period of uplink synchronization data.

One example of a validity timer is the timing advance timer, which may used by UE 110 to evaluate whether or not it has a valid (uplink) synchronization to the serving cell. Each time UE 110 receives a timing advance update, it may reset or restart the timer. Upon expiry of the timer, UE 110 may enter a state where it assumes that it is not synchronized to the network anymore. UE 110 may then determine to detect downlink synchronization signals again and perform the RA procedure, or at least obtain a new timing advance command, which may alternatively be provided through a PDCCH-ordered RACH procedure. This enables both UE 110 and gNB 120 to be aware of the time by which UE 110 will potentially lose its uplink time synchronization and gNB 120 may therefore determine the exact time when UE 110 potentially enters the non-synchronized state.

In case of non-terrestrial networks, a validity timer maybe defined for the ephemeris data. UE 110 may use the ephemeris data along with the GNSS-provided UE location information for calculating the UE-specific timing advance. A validity timer may be also defined for the common TA and optionally for further assistance information provided by gNB 120 for calculation of the feeder link timing advance. In some example embodiments, a single timer may be used for both ephemeris data, the common TA, and optionally the further assistance information.

However, if UE 110 is not mandated to read the uplink synchronization data (e.g. ephemeris data or common TA) at specific time instants, gNB 120 can not determine the exact time of the most recent acquisition of the uplink synchronization data by UE 110. Consequently, gNB 120 may not be aware of when the corresponding timer expires and UE 110 will potentially be out of synchronization. For example, some UEs may have a more advanced propagator model and might therefore read the ephemeris data less frequently than other UEs having less accurate propagator models for tracking and predicting movement of satellite 130. If gNB 120 is not aware of the synchronization status of UE 110, gNB 120 may not be able to schedule data transmissions optimally, which may degrade network performance. For example, if gNB 120 schedules UE 110 for PUSCH transmission and UE 110 does not have valid ephemeris information (e.g. in order to calculate UE-specific TA or to perform UL Doppler frequency compensation), UE 110 may need to fall back to the RA procedure to re-establish uplink synchronization, instead of responding to the uplink scheduling and transmitting data using the scheduled PUSCH resources. As another example, if UE 110 is scheduled with PDSCH, but UE 110 is not able to provide HARQ-ACK (hybrid automatic repeat request acknowledgement) feedback on the physical uplink control channel (PUCCH) due to not having a valid ephemeris information, gNB 120 may unnecessarily re-transmit the PDSCH transmission.

Example embodiments of the present disclosure therefore address the issues arising from the uncertainty about the synchronization status of UE 110 at gNB 120. As will be further described below, gNB 120 is enabled to schedule both downlink and uplink data transmissions for UE more efficiently and to avoid dropped downlink and/or uplink transmissions.

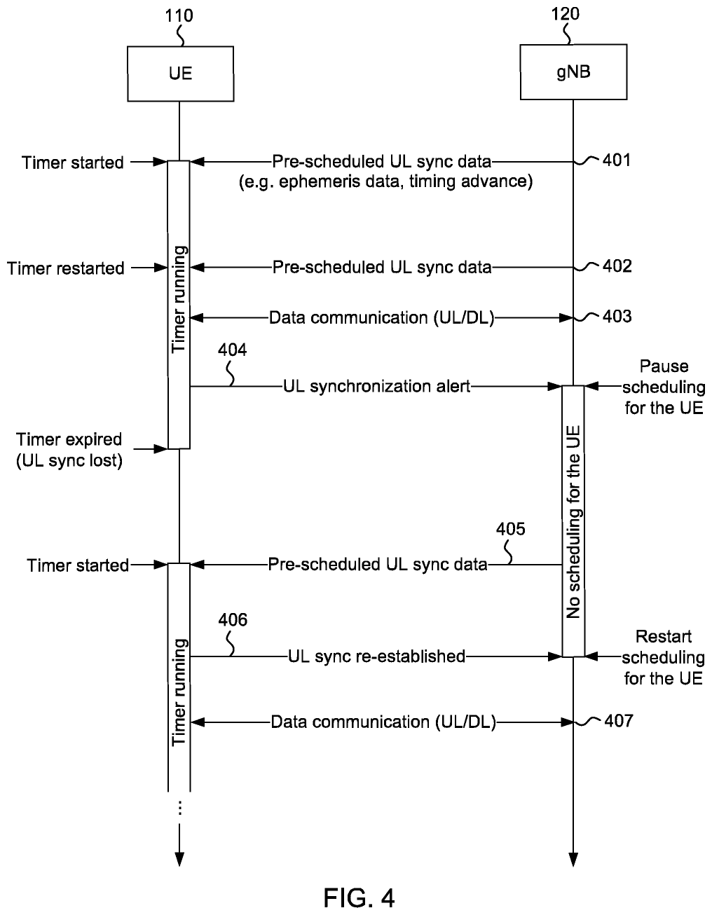

FIG. 4 illustrates example of re-establishing uplink synchronization. Even though the procedure has been illustrated to take place between UE 110 and gNB 130, it is appreciated that transmissions between UE 110 and gNB 120 may be performed via a non-terrestrial network node, represented in this example by satellite 130. Alternatively, gNB 120 may in some embodiments be integrated within satellite 130. In either case gNB 120 may be a NTN-enabled gNB. If gNB 120 is deployed on the earth, it may be called a terrestrial network node or a terrestrial access node.

At operation 401, gNB 120 may transmit uplink synchronization data to UE 110, for example in a pre-scheduled uplink synchronization assistance signal. Transmission of the uplink synchronization data may be therefore pre-scheduled. For example, gNB 120 may be configured to broadcast the uplink synchronization data periodically or with irregular intervals. The pre-scheduled uplink synchronization assistance signal may therefore comprise a broadcast signal. The pre-scheduled uplink synchronization assistance signal may for example comprise a SIB, which may be transmitted on PBCH.

The uplink synchronization data may comprise data that enables UE 110 to perform uplink synchronization or assists UE 110 in performing uplink synchronization with gNB 120. Uplink synchronization may refer to a process carried out by UE 110 in order to be able to transmit data at a sufficiently correct time such that gNB 120 is able to receive the data. Performing uplink synchronization may comprise for example determining one or more timing advance values for data transmissions to gNB 120. The uplink synchronization data may for example comprise ephemeris data of satellite 130, which enables non-terrestrial communication between UE 110 and gNB 120. The uplink synchronization data may comprise a common TA, which may be associated with the feeder link between satellite 130 and gNB 120. The common TA may be therefore common for all UEs served by satellite 130. The uplink synchronization data may further comprise higher order derivatives of the common TA, for example common TA drift rate, common TA drift rate variation etc., corresponding to the feeder link TA. In general, the uplink synchronization data may comprise at least an n-th order derivative of the common TA associated with the feeder link. The uplink synchronization data may for example comprise a first order derivative of the common TA, or, first and second order derivatives of the common TA. In some embodiments, the uplink synchronization data may therefore comprise a plurality of common TA derivatives of different orders. The uplink synchronization data may comprise a UE-specific TA, which may be associated with the feeder link and/or the service link between UE 110 and satellite 130. The UE-specific TA may therefore indicate a full TA for UE 110, including contributions from both the feeder link and the service link. In order to calculate the service link TA, gNB 120 may measure the end-to-end delay from UE 110 to gNB 120, for example as part of the random access procedure or by means of using a time-stamped packet exchange or a network time protocol.

In response to receiving the uplink synchronization data, UE 110 may start a timer to monitor expiry of the validity period of the uplink synchronization data. The timer may be started from an initial value indicative of the length of the validity period and counted towards zero. In general, UE 110 may determine at least one expected expiry time for the uplink synchronization data. This may be done by any suitable means so the use of timer(s) is just one example. As noted above, UE 110 may also monitor multiple timers in parallel, each timer being associated with one or more parameters of the uplink synchronization data. Eve though some example embodiments have been described with reference to one timer, it is appreciated that such example embodiments may be also applied in case of more than one timer.

At operation 402, gNB 120 may again transmit uplink synchronization data, similar to operation 401. The data may comprise updated uplink synchronization data compared to the uplink synchronization data provided at operation 401. For example, ephemeris data and/or timing advance information may be different from operation 401. In response to receiving the updated uplink synchronization data, UE 110 may restart the timer from its initial value.

At operation 403, UE 110 and gNB 120 may communicate (transmit and/or receive) data using scheduled data transmission(s). As long as the timer is running, i.e. the validity period has not expired, gNB 120 may perform normal operations such as scheduling of the data transmissions for both downlink and uplink data.

At operation 404, UE 110 may determine that the timer is about to expire. UE 110 may for example determine that the timer is expected to expire within a threshold time configured for triggering transmission of an alert of the expected expiry of the validity period to gNB 120. The threshold time may be preconfigured at UE 110 or UE 110 may receive the threshold time from gNB 120. UE 110 may transmit the alert of the expected expiry of the validity period of the uplink synchronization data. The alert (“UL synchronization alert”) may comprise or be transmitted along with an indication of the remaining time to the expected expiry of the timer. This enables gNB 120 to be informed about the expected expiry of the timer and/or the expected expiry time of the timer. In case of multiple timers, UE 110 may transmit the alert in response to determining that at least one of the timers is expected to expire within the threshold time. The alert may be transmitted as any suitable alert signal. The alert signal may be sent for example on UE-specific and pre-configured transmission resources of an uplink channel (e.g. PUCCH). Optionally, UE 110 may request the uplink transmission resources for the alert signal from gNB 120.

Alternatively, or additionally, UE 110 may determine to transmit the alert, in response to determining that the validity period is expected to expire before reception of a next pre-scheduled uplink synchronization assistance signal. The schedule of the uplink synchronization assistance signals comprising the uplink synchronization data may be known to UE 110 and therefore UE 110 may determine not to send the alert if the next uplink synchronization assistance signal is scheduled such that UE 110 receives it before the validity period expires. When the timer finally expires, UE 110 may determine that uplink synchronization is lost.

In response to receiving the alert, gNB 120 may perform counteraction(s) to avoid unnecessary scheduling of data transmissions for UE 110. As in the example of FIG. 4, gNB 120 may pause scheduling of data transmissions for UE 110. For example, gNB 120 may immediately, or with a short notice to inform UE 110, stop any traffic that causes uplink transmissions (e.g. refrain from scheduling of downlink data and/or grant(s) for uplink transmission). Pausing the scheduling may comprise not scheduling data transmissions for UE 110 either immediately after reception of the alert or after the expiry time of the validity period. Scheduling may be paused until UE 110 has re-established uplink synchronization. An indication of the paused scheduling of the data transmissions may be transmitted by gNB 120 to UE 110. The indication may inform UE 110 about pausing the scheduling until re-establishment of the uplink synchronization. UE 110 may therefore continue decoding the pre-scheduled uplink synchronization assistance signals, which gNB 120 may continue to transmit regardless of pausing the scheduling of data transmissions for UE 110.

At operation 405, gNB 120 may again transmit uplink synchronization data within a pre-scheduled uplink synchronization assistance signal, similar to operations 401 and 402. The pre-scheduled uplink synchronization assistance signal may be transmitted after expiry of the validity period. At this time, scheduling of the data transmissions for UE 110 may be paused so there may be no scheduling of uplink or downlink data transmissions for UE 110. The pre-scheduled uplink synchronization assistance signal may comprise updated uplink synchronization data, which may be different from operation 402.

UE 110 may perform uplink synchronization with the updated uplink synchronization data. UE 110 may therefore re-establish uplink synchronization, in response to receiving (e.g. correctly decoding) the pre-scheduled uplink synchronization assistance signal. Since UE 110 has received updated uplink synchronization data, it may start the timer. The timer may be started from its initial value indicative of the length of the validity period.

At operation 406, UE 110 may transmit an indication of re-established uplink synchronization to gNB 120. This indication may be transmitted on a pre-configured channel, for example PUCCH, contention-free transmission resource(s) of PRACH, or other uplink transmission resource(s) dedicated to UE 110.

In response to receiving the indication of re-established uplink synchronization, gNB 120 may restart scheduling of data transmissions for UE 110.

At operation 407, UE 110 and gNB 120 may communicate data using the scheduled data transmission(s), similar to operation 403.

The above procedure enables gNB 120 to avoid unnecessary scheduling of data transmissions to UE 110. This improves overall capacity of the network, because the saved transmission resources may be assigned to other data traffic.

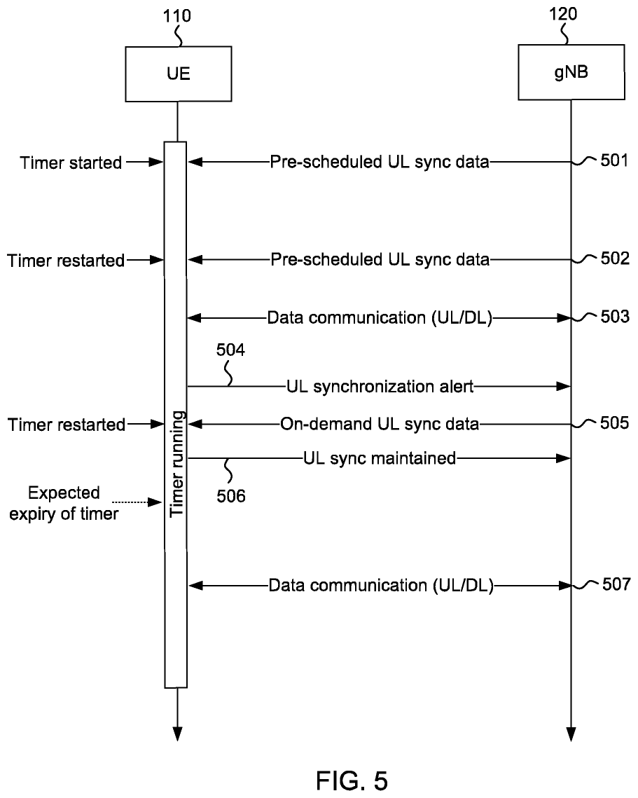

FIG. 5 illustrates an example of on-demand delivery of uplink synchronization data.

At operations 501 and 502, gNB 120 may transmit pre-scheduled uplink synchronization assistance signals comprising the uplink synchronization data to UE 110, similar to operations 401 and 402.

At operation 503, UE 110 and gNB 120 may communicate data using the scheduled data transmission(s), similar to operation 403.

At operation 504, UE 110 may transmit the UL synchronization alert, similar to operation 404. In response to receiving the alert, gNB 120 may perform counteraction(s) to avoid unnecessary scheduling of data transmissions for UE 110. In the example of FIG. 5, scheduling of the data transmissions may be continued, but gNB 120 avoids the scheduling to be unnecessary by enabling UE 110 to maintain uplink synchronization, as provided below.

At operation 505, gNB 120 may transmit an on-demand uplink synchronization assistance signal, which may comprise updated uplink synchronization data. The on-demand uplink synchronization assistance signal may be specific to UE 110. For example, the on-demand uplink synchronization assistance signal may be transmitted using downlink transmission resources dedicated to UE 110 and/or the on-demand uplink synchronization assistance signal may be addressed to UE 110. The on-demand uplink synchronization assistance signal may be transmitted for example on PDCCH. This signal enables UE 110 to maintain uplink synchronization and to restart the timer before its expected expiry time. If uplink transmission resources are needed or have been earlier requested by UE 110, gNB 120 may assign uplink transmission resources to UE 110 via the associated PDCCH. This solution may be beneficial for example in case of high priority UE transmission or if it is desired to maintain the uplink synchronization without interruption. UE 110 may receive the on-demand uplink synchronization assistance signal before expiry of the timer, i.e., before expiry of the validity period.

In response to receiving the on-demand uplink synchronization assistance signal, UE 110 may perform uplink synchronization based on the updated uplink synchronization data included in the on-demand uplink synchronization assistance signal. Since UE 110 is already synchronized (timer is still running), UE 110 may maintain uplink synchronization based on the received on-demand uplink synchronization data. UE 110 may restart the timer. The expected expiry time may be postponed accordingly. Uplink synchronization may be therefore maintained longer than without receiving the on-demand uplink synchronization data.

At operation 506, UE 110 may transmit an indication of maintained uplink synchronization to gNB 120. This indication may be transmitted on a pre-configured channel, for example PUCCH, contention-free transmission resource(s) of PRACH, or other uplink transmission resource(s) dedicated to UE 110. The indication may be provided for example by transmitting an acknowledgement (message) to the on-demand uplink position assistance signal delivered at operation 505. Alternatively, the indication may be provided on a separate channel, for example after processing the updated uplink synchronization data (e.g. ephemeris data) by higher layer(s). The indication may for example comprise an indication that UE 110 has restarted the timer. UE 110 may also indicate the initial value of the timer or the (updated) expected expiry time of the validity period.

In response to receiving the indication of maintained uplink synchronization, gNB 120 may continue (i.e. not pause) scheduling of data transmissions for UE 110.

At operation 507, UE 110 and gNB 120 may communicate data using the scheduled data transmission(s), similar to operation 403.

The procedure of FIG. 5 enables UE 110 to maintain uplink synchronization, which enables scheduling of data transmissions to continue without interruption. It is however noted that operations of FIG. 4 and FIG. 5 may be used in combination, for example such that if gNB 120 does not receive the indication of maintained synchronization at operation 506 before the expiry of the validity period, gNB 120 may pause scheduling of the data transmissions for UE 110 (cf. operation 404). A new on-demand uplink synchronization signal, or a new pre-configured uplink synchronization signal may be subsequently transmitted to UE 110, which may enable UE 110 to re-establish the uplink synchronization, resulting in the indication of the re-established uplink synchronization (cf. operation 406) to be transmitted by UE 110 to gNB 120.

The decision of whether to transmit the on-demand uplink synchronization assistance signal may be optionally based on a priority level associated with the data to be communicated. For example, gNB 120 may determine to transmit the on-demand uplink synchronization assistance signal, in response to determining that a priority level associated with the data transmissions meets a condition. For example, if the priority level is above (or equal) to a threshold (i.e. more prioritized), gNB 120 may determine to transmit the on-demand uplink synchronization assistance signal. If the priority level is lower (or equal) to the threshold, gNB 120 may determine not transmit the on-demand uplink synchronization assistance signal. In the latter case, gNB 120 may continue to transmit the pre-scheduled uplink synchronization assistance signals. This enables to avoid service interruptions for high-priority data, while also enabling to avoid unnecessary scheduling of low-priority data. Scheduling of the low-priority data may continue later after re-establishment of the uplink synchronization.

Example embodiments of the present disclosure provide a flexible approach for mitigating adverse effects of losing uplink synchronization. UE 110 may be assisted to maintain uplink synchronization, but on the other hand scheduling of data transmissions may be paused to optimize network traffic if UE 110 can not maintain the uplink synchronization.

In general, a benefit for gNB 120 and network performance is that unnecessary downlink transmissions and UE scheduling grants may be avoided. Otherwise, the related transmission resources would be wasted, because UE 110 would not be able to use them in the non-synchronized state. Moreover, providing UE-specific synchronization information on an on-demand basis enables to avoid interruption of desired UE transmissions, for example those associated with high priority. Finally, from the UE perspective the example embodiments provide the benefit of faster re-establishment of synchronization based on the on-demand uplink synchronization data. A delay associated with waiting for the next opportunity when the pre-scheduled synchronization information is broadcasted again may be therefore avoided.

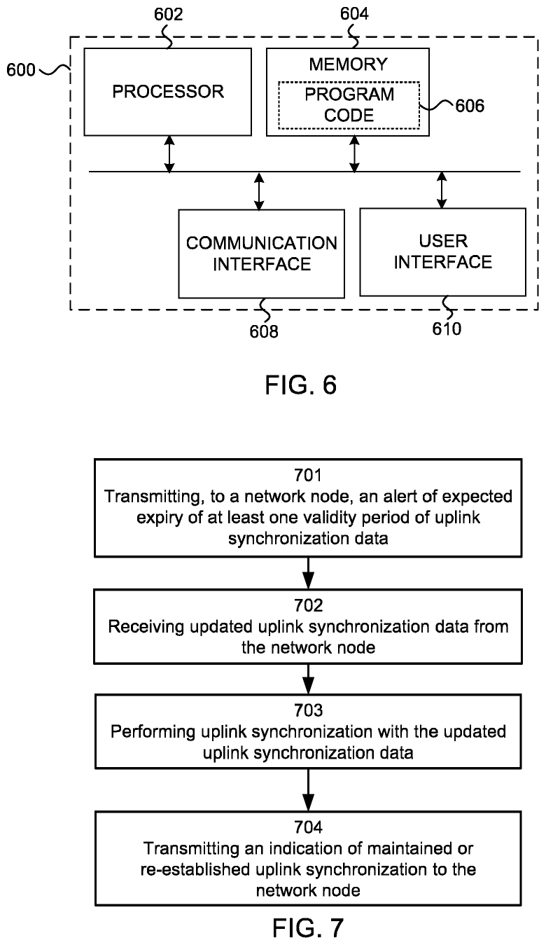

FIG. 6 illustrates an example embodiment of an apparatus 600, for example UE 110, gNB 120, satellite 130, or a component or a chipset of UE 110, gNB 120, or satellite 130. Apparatus 600 may comprise at least one processor 602. The at least one processor 602 may comprise, for example, one or more of various processing devices or processor circuitry, such as for example a co-processor, a microprocessor, a controller, a digital signal processor (DSP), a processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, or the like.

Apparatus 600 may further comprise at least one memory 604. The at least one memory 604 may be configured to store, for example, computer program code or the like, for example operating system software and application software. The at least one memory 604 may comprise one or more volatile memory devices, one or more non-volatile memory devices, and/or a combination thereof. For example, the at least one memory 604 may be embodied as magnetic storage devices (such as hard disk drives, floppy disks, magnetic tapes, etc.), optical magnetic storage devices, or semiconductor memories (such as mask ROM, PROM (programmable ROM), EPROM (erasable PROM), flash ROM, RAM (random access memory), etc.).

Apparatus 600 may further comprise a communication interface 608 configured to enable apparatus 600 to transmit and/or receive information to/from other devices. In one example, apparatus 600 may use communication interface 608 to transmit or receive signaling information and/or data in accordance with at least one cellular (e.g. non-terrestrial) communication protocol and/or one or more GNSS protocols. The communication interface may be configured to provide at least one wireless radio connection, such as for example a 3GPP mobile broadband connection (e.g. 3G, 4G, 5G, 6G). However, the communication interface may be configured to provide one or more other type of connections, for example a wireless local area network (WLAN) connection such as for example standardized by IEEE 802.11 series or Wi-Fi alliance; a short range wireless network connection such as for example a Bluetooth, NFC (near-field communication), or RFID connection; a wired connection such as for example a local area network (LAN) connection, a universal serial bus (USB) connection or an optical network connection, or the like; or a wired Internet connection. The communication interface 608 may comprise, or be configured to be coupled to, an antenna or a plurality of antennas to transmit and/or receive radio frequency signals. One or more of the various types of connections may be also implemented as separate communication interfaces, which may be coupled or configured to be coupled to an antenna or a plurality of antennas.

Apparatus 600 may further comprise a user interface 610 comprising an input device and/or an output device. The input device may take various forms such a keyboard, a touch screen, or one or more embedded control buttons. The output device may for example comprise a display, a speaker, a vibration motor, or the like.

When apparatus 600 is configured to implement some functionality, some component and/or components of apparatus 600, such as for example the at least one processor 602 and/or the at least one memory 604, may be configured to implement this functionality. Furthermore, when the at least one processor 602 is configured to implement some functionality, this functionality may be implemented using the program code 606 comprised, for example, in the at least one memory 604.

The functionality described herein may be performed, at least in part, by one or more computer program product components such as software components. According to an embodiment, the apparatus comprises a processor or processor circuitry, such as for example a microcontroller, configured by the program code when executed to execute the embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), application-specific Integrated Circuits (ASICs), application-specific Standard Products (ASSPs), System-on-a-chip systems (SOCs), Complex Programmable Logic Devices (CPLDs), Graphics Processing Units (GPUs).

Apparatus 600 may in general comprise means for performing one or more of the example embodiments described herein. In one example, the means comprises the at least one processor 602, the at least one memory 604 including program code 606 configured to, when executed by the at least one processor, cause the apparatus 600 to perform the method. The operations described may be carried out by computer program instructions running on means, for example the at least one processor 602 and the at least one memory 604, which may provide generic data processing functions. Such means may be embedded for example in a smartphone, access node, satellite, vehicle, or the like. The means may comprise radio transmitting and/or receiving means, for example antenna(s), baseband circuitry, and/or radio frequency circuitry, or the means may carry out data processing functions and be, or be configured to be, coupled to an external radio head, or the like, for transmission and reception of radio frequency signals.

Apparatus 600 may comprise a computing device such as for example an access node, a server, a mobile phone, a tablet computer, a laptop, an internet of things (IoT) device, or the like. Examples of IoT devices include, but are not limited to, consumer electronics, wearables, sensors, and smart home appliances. In one example, apparatus 600 may comprise a vehicle such as for example a car. Although apparatus 600 is illustrated as a single device it is appreciated that, wherever applicable, functions of apparatus 600 may be distributed to a plurality of devices, for example to implement example embodiments as a cloud computing service.

FIG. 7 illustrates an example of a method for uplink synchronization.

At 701, the method may comprise transmitting, to a network node, an alert of expected expiry of at least one validity period of uplink synchronization data.

At 702, the method may comprise receiving updated uplink synchronization data from the network node.

At 703, the method may comprise performing uplink synchronization with the updated uplink synchronization data.

At 704, the method may comprise transmitting an indication of maintained or re-established uplink synchronization to the network node.

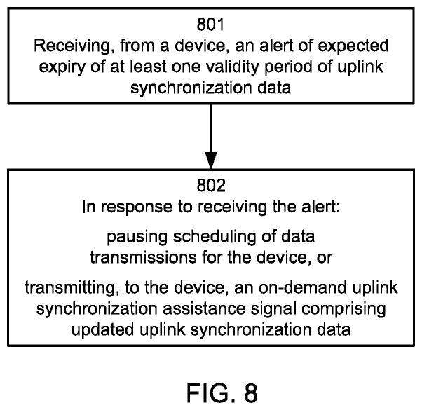

FIG. 8 illustrates an example of a method for enabling uplink synchronization.

At 801, the method may comprise receiving, from a device, an alert of expected expiry of at least one validity period of uplink synchronization data.

At 802, the method may comprise: in response to receiving the alert: pausing scheduling of data transmissions for the device, or transmitting, to the device, an on-demand uplink synchronization assistance signal comprising updated uplink synchronization data.

Further features of the methods directly result from the functionalities and parameters of the UE 110, gNB 130, and/or satellite 130, or in general the apparatus 600, as described in the appended claims and throughout the specification, and are therefore not repeated here. Different variations of the methods may be also applied, as described in connection with the various example embodiments.

An apparatus may be configured to perform or cause performance of any aspect of the method(s) described herein. Further, a computer program or a computer program product may comprise instructions for causing, when executed, an apparatus to perform any aspect of the method(s) described herein. Further, an apparatus may comprise means for performing any aspect of the method(s) described herein. The means may comprise at least one processor and at least one memory including computer program code, the at least one memory and computer program code configured to, with the at least one processor, cause performance any aspect of the method(s) by the apparatus.

Any range or device value given herein may be extended or altered without losing the effect sought. Also, any embodiment may be combined with another embodiment unless explicitly disallowed.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item may refer to one or more of those items.

The steps or operations of the methods described herein may be carried out in any suitable order, or simultaneously where appropriate. Additionally, individual blocks may be deleted from any of the methods without departing from the scope of the subject matter described herein. Aspects of any of the embodiments described above may be combined with aspects of any of the other embodiments described to form further embodiments without losing the effect sought.

The term ‘comprising’ is used herein to mean including the method, blocks, or elements identified, but that such blocks or elements do not comprise an exclusive list and a method or apparatus may contain additional blocks or elements.

As used in this application, the term ‘circuitry’ may refer to one or more or all of the following: (a) hardware-only circuit implementations (such as implementations in only analog and/or digital circuitry) and (b) combinations of hardware circuits and software, such as (as applicable):(i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions) and (c) hardware circuit(s) and or processor(s), such as a microprocessor(s) or a portion of a microprocessor(s), that requires software (e.g., firmware) for operation, but the software may not be present when it is not needed for operation. This definition of circuitry applies to all uses of this term in this application, including in any claims.

As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from scope of this specification.

1. An apparatus, comprising:
at least one processor; and
at least one memory including computer program code; the at least one memory and the computer program code configured to, with the at least one processor, cause the apparatus at least to:
transmit, to a network node, an alert of expected expiry of at least one validity period of uplink synchronization data;
receive updated uplink synchronization data from the network node;
perform uplink synchronization with the updated uplink synchronization data; and
transmit an indication of maintained or re-established uplink synchronization to the network node.

2. The apparatus according to claim 1, wherein the uplink synchronization data comprises at least one of:
ephemeris data of a non-terrestrial network node,
a common timing advance associated with a feeder link, wherein the feeder link is a link between the non-terrestrial network node and the network node,
at least an n-th order derivative of the common timing advance associated with the feeder link, or
a device-specific timing advance associated with the feeder link and/or a service link, wherein the service link is a link between the non-terrestrial network node and the apparatus

3. The apparatus according to claim 1, wherein the non-terrestrial network node comprises a satellite, and/or wherein the network node comprises a terrestrial network node.

4. The apparatus according to claim 1, wherein the at least one memory and the computer program code are further configured to, with the at least one processor, cause the apparatus to:
determine to transmit the alert, in response to determining that the at least one validity period is expected to expire before reception of a pre-scheduled uplink synchronization assistance signal.

5. The apparatus according to claim 4, wherein the at least one memory and the computer program code are further configured to, with the at least one processor, cause the apparatus to:
receive, after expiry of the at least one validity period, the pre-scheduled uplink synchronization assistance signal, wherein the pre-scheduled uplink synchronization assistance signal comprises the updated synchronization data;
perform synchronization or re-establish uplink synchronization with the updated uplink synchronization data; and
transmit the indication of the re-established uplink synchronization to the network node.

6. The apparatus according to claim 4, wherein the pre-scheduled uplink synchronization assistance signal comprises a broadcast signal.

7. The apparatus according to claim 1, wherein the at least one memory and the computer program code are further configured to, with the at least one processor, cause the apparatus to:
receive an indication of paused scheduling of data transmissions.

8. The apparatus according to claim 1, wherein the at least one memory and the computer program code are further configured to, with the at least one processor, cause the apparatus to:
receive, before expiry of the at least one validity period, an on-demand uplink synchronization assistance signal comprising the updated synchronization data; and
transmit the indication of the maintained uplink synchronization to the network node.

9. The apparatus according to claim 8, wherein the on-demand uplink synchronization assistance signal is a device-specific signal.

10. The apparatus according to claim 8, wherein the indication of the maintained uplink synchronization comprises an acknowledgement of the on-demand uplink synchronization assistance signal.

11. The apparatus according to claim 1, wherein the at least one memory and the computer program code are further configured to, with the at least one processor, cause the apparatus to:
transmit the indication of the maintained or re-established uplink synchronization on a physical uplink control channel, at least one contention-free transmission resource of a physical random access channel, or at least one uplink transmission resource dedicated to the apparatus.

12. The apparatus according to claim 1, wherein the at least one memory and the computer program code are further configured to, with the at least one processor, cause the apparatus to:
communicate data with the network node using at least one scheduled data transmission after transmitting the indication of the maintained or re-established uplink synchronization.

13. An apparatus, comprising:
at least one processor; and
at least one memory including computer program code; the at least one memory and the computer program code configured to, with the at least one processor, cause the apparatus at least to:
receive, from a device, an alert of expected expiry of at least one validity period of uplink synchronization data; and
in response to receiving the alert:
pause scheduling of data transmissions for the device, or
transmit, to the device, an on-demand uplink synchronization assistance signal comprising updated uplink synchronization data.

14. The apparatus according to claim 13, wherein the uplink synchronization data comprises at least one of:
ephemeris data of a non-terrestrial network node,
a common timing advance associated with a feeder link, wherein the feeder link is a link between the non-terrestrial network node and a terrestrial network node,
at least an n-th order derivative of the common timing advance associated with the feeder link, or
a device-specific timing advance associated with the feeder link and a service link, wherein the service link is a link between the device and the non-terrestrial network node.

15. The apparatus according to claim 13, wherein the at least one memory and the computer program code are further configured to, with the at least one processor, cause the apparatus to:
transmit a pre-scheduled uplink synchronization assistance signal comprising the updated uplink synchronization data.

16. The apparatus according to claim 15, wherein the pre-scheduled uplink synchronization assistance signal comprises a broadcast signal.

17. The apparatus according to claim 13, wherein the at least one memory and the computer program code are further configured to, with the at least one processor, cause the apparatus to:
restart scheduling of data transmissions for the device, in response to receiving an indication of re-established uplink synchronization from the device.

18. The apparatus according to claim 13, wherein the on-demand uplink synchronization assistance signal comprises a device-specific signal.

19. The apparatus according to claim 13, wherein the at least one memory and the computer program code are further configured to, with the at least one processor, cause the apparatus to:
determine to transmit the on-demand uplink synchronization assistance signal, in response to determining that a priority level associated with the data transmissions meets a condition.

20-23. (canceled)

24. A method, comprising:
transmitting, to a network node, an alert of expected expiry of at least one validity period of uplink synchronization data;
receiving updated uplink synchronization data from the network node;
performing uplink synchronization with the updated uplink synchronization data; and
transmitting an indication of maintained or re-established uplink synchronization to the network node.

25-29. (canceled)
